(19) United States
(12) Patent Application Publication
(10) Pub. No.: US 2026/0310425 A1
(43) Pub. Date: Oct. 8, 2026

(54) AUTOMATED CODE GENERATION FOR UPDATING SOFTWARE PLATFORM INTEGRATIONS WITH COMPUTING SERVICES

(71) Applicant: PAYPAL, INC., San Jose, CA (US)

(72) Inventors: Asish Mohanty, Santa Clara, CA (US); Chandra Sekhar Nallam, Lathrop, CA (US); Navinkumar Patil, San Jose, CA (US); Rajesh Selvaraj, Fremont, CA (US); Roshan Thomas, Concord, CA (US); Mudita Tiwari, Cupertino, CA (US); Shivani Bayala Banerjee, San Jose, CA (US)

(21) Appl. No.: 19/169,602

(22) Filed: Apr. 3, 2025

(51) Int. Cl. G06F 8/35; G06F 8/36

(52) U.S. Cl. CPC G06F 8/35; G06F 8/36

(57) ABSTRACT

There are provided systems and methods for automated code generation for updating software platform integrations with computing services. An online transaction processor or other service provider may provide computing services and platforms to entities including merchants for electronic transaction processing and other account services. To provide for use of computing services on or with other external and/or third-party software platforms, the service provider may provide different customer entities, such as merchants that use a transaction processor service, with a digital platform having an integration detection tool and code migration tool. These tools may enable the entities to have code analyzed using a large language model (LLM) to determine the code integrations existing in the code, and whether those integrations are recommended to be upgraded. If so, the tools may utilize an LLM to generate code without human efforts, which may be used for software code updates.

### TECHNICAL FIELD

The present application generally relates to computing service and software integrations on digital platforms, and more particularly to providing predictive and streamlined processes to integrate computing services on different software platforms.

### BACKGROUND

Online service providers may offer various services to end users, merchants, and other entities. This may include providing computing services through different software applications, websites, platforms, and resources, such as those that may be involved with digital transaction processing. For example, computing services may include those used to process transactions through electronic transaction processing data flows, services, and other computing resources. Further, the service provider may provide and/or facilitate the use of applications and websites for online payments, peer-to-peer (P2P) transfers, and/or marketplaces to different entities including merchants.

However, establishment and use of these computing services require merchants and other entities to onboard with the service provider, identify a computing service of interest or need, and integrate those computing services with the merchant through an external or third-party software platform separate from the service provider. Determining these services and code integrations may not be streamlined and/or may require significant amounts of time in developing, testing, and implementing the computing code and services with different platforms. Further, merchants with legacy computing code and code integrations may not utilize newer, faster, and/or more efficient computing services and resources, leading to inefficient computing systems and wasted resources and processing time. As such, there is a need to provide a more streamlined, faster, and automated process to facilitate the integration of computing services with new and improved integrations with increased capabilities for computing service execution and usage.

### BRIEF DESCRIPTION OF THE DRAWINGS

FIG. 1 is a block diagram of a networked system suitable for implementing the processes described herein, according to an embodiment;

FIG. 2 is an exemplary computing environment for computing code generation for code integrations of software platforms with computing services, according to an embodiment;

FIGS. 3A and 3B are exemplary diagrams of calls between different systems and services when generating computing code for computing service integrations of software platforms, according to various embodiments;

FIG. 4 is a flowchart for automated code generation for updating software platform integrations with computing services, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for automated code generation for updating software platform integrations with computing services. Systems suitable for practicing methods of the present disclosure are also provided.

Online service providers may offer computing services for different end users, including individual consumers and customers, as well as merchants, businesses, and other entities that may engage with individual users and other entities. For example, one type of service provider may be an online transaction processor, which may be utilized to process transactions digitally and provide transactional services over large networks and using network communications for transaction coordination, authorization, authentication, and other requirements that enable increased transaction speed, trustworthiness, asset or fund exchange, deposits and withdrawals, risk assessments, fraud detection, antimony laundering processes, and the like. To utilize such services of an online service provider offering these digital transaction processing services, a user's device may be utilized. While it may be straightforward for individual users to download an application and familiarize themselves with such an application provided by the service provider, with entities, such as merchants, this is a much more difficult task. From inventory to payroll, each merchant or other entity may have their own computer system, software, and other software platform that they utilize to interact with their customers or other business needs.

In one example, a user may wish to process a transaction, such as for a payment to another user or a transfer, through an online service provider. The user may pay for one or more transactions using a digital wallet or other account with the online service provider, such as a digital transaction processor (e.g., PayPal®). As such, a merchant may utilize these online service providers for particular computing services, such as to process transactions, create and/or login to accounts with the service provider and/or the merchant, provide risk analysis and/or fraud detection, and other computing services provided through applications, websites, resources, and processors of the service provider. Other service providers may also provide different services to other types of entities, such as computing services for social networking, microblogging, media sharing, messaging, business and consumer platforms, and the like.

As such, the merchant (and/or other entities) may have software platforms, such as applications and websites, where the merchants may offer their products, services, and other items to users, such as customers and consumers. These merchants may require use of such platforms for operation of their business, such as platforms of other service providers that are not directly compatible and would normally not directly interact and establish a particular set of processes to handle their interactions, requests, and responses. When offering items for sale, the merchant may desire to incorporate the service provider's computing services within their software platform so that the service may be provided, accessed, and/or linked on the merchant's platform in place of requiring users to navigate to the service provider's application, website, and/or other platform. In order for merchants to provide the services of the service provider to users for processing transactions with the merchants, the service provider may provide operations for merchants to onboard and setup software and computing code integrations with the service provider through one or more merchant websites, systems, applications, and the like. However, inefficient and lengthy processes with detailed requirements often leave updating of such integration forgotten or incomplete, which causes merchants and other entities to utilize old, slow, and/or compromised processes and systems. As such, a service provider may provide a digital platform and tools for identifying an entity's software code integrations automatically and on behalf of the entity based on data provided and permitted access by the entity. This digital platform and tools may therefore provide computing integrations of entity systems that result in more efficient, faster, more secure, and/or improved computing service usage and implementation.

For example, with an online transaction processor or other type of payment service provider, the service provider may provide an account to an entity for access to and/or use of account-restricted computing services, such as those that may require some level of trust or known history between the parties. As such, the entity's account may be associated with different historical data, which may provide insight and is relevant to the interests, needs, or categorization of that entity. During setup of an account, merchants or other entities may onboard with the service provider to obtain access to computing services for utilization with their business and corresponding software platform. This may include accessing computing service setups (including software development kit (SDK) usage and setup, code snippets, and other data for code integrations of the service provider's computing service(s) with the merchant's software platform), application and/or website setup and configuration, and the like. The service provider's digital platform for computing service integrations may offer application programming interface (API) specifications and documentation, developer tools, software manuals, and other types of assistance may be provided to entities to better facilitate development of computing code, call structure, and other software components necessary for interfacing between the entity's software platform and the computing services of the service provider.

Further the code integration platform of the service provider may provide operations and tools for integration detection, tracking, and reporting or summarizing for the entities that utilize the computing services and products of the service provider, as well as a code migration assistant tool and/or interface where entities may directly interface with artificial intelligence systems such as a large language model (LLM) and/or other generative AI-based system capable of generating and/or transforming previously used computing code for code integrations to a new, most current, and/or updated version of the computing code that may be required and/or utilized for that purpose or task. Conventionally, merchants and other entities would be required to manually perform code integrations of computing services with software platforms, which is time consuming and labor intensive, and may lead to inefficient or suboptimal solutions, thereby creating computing systems that waste computing resources, processing power, and/or encounter errors and failures. However, using the platform and tool provided by a service provider, as discussed herein, creation of new and/or updating of previous code integrations may be performed quickly, efficiently, and with less errors or manual efforts required to input such code. As such, entities may provide software platforms with more secure and resource efficient integrations with their service providers.

As such, a service provider, as discussed herein, may provide an intelligent artificial intelligence (AI) system that may implement machine learning (ML) models, neural networks (NNs), LLMs, and the like for automated creation and/or updating of computing code used for code integrations for external, third party, or separate software platforms with the requirements, capabilities, and/or specifications of the computing services provided by the service provider. This may be done using two or more separate, distinct, but interacting modules and components of the digital platform. First, a resource, extension, and/or tool may perform an integration detection and/or migration path recommendation by identifying the existing code integrations on a software platform and their versions, as well as if those versions are recommended to be updated. Second, another resource, extension, or tool may perform code migrations and/or transformations by generating computer code to update the existing code integrations and their versions to a newer, more highly recommended, more compatible, or otherwise selected version of that code integration. These tools may be accessible to entities via a website or application and may reside in a cloud computing environment or similar for the service provider. Further, the tools and services for code updates, migrations, and transformations may be usable through an extension, application, or add-on that may be provided to entities for installation and use on their computer systems.

The first tool for integration detection and migration path recommendation, such as an integration detection tool, may include and/or utilize an LLM or other generative AI of the AI system of the service provider. In other embodiments, the first tool may utilize one or more AI processes, models, or engines from the service provider's AI system that may process code, calls, account data, or the like to identify a version of computing code running on the entity's computer system and used for a code integration with the service provider. For example, the integration detection tool may receive an upload of a data package, such as a . zip file or other compressed file type, that includes code for the entity's computer system or other computing platform and the code integration of the entity. Acting as an extension on the entity's computer system, the integration detection tool server-side may utilize a device-side component to scan and parse the entity's computer system and/or files specifically for the code integration. A consent may be asked from the user prior to scanning, parsing, and/or otherwise processing the entity's code, which may include privacy consent and data privacy requirements. This may be done through the merchant's computer system and the extension that is installed, or may be done in-application, on a website, and the like.

The AI system of the integration detection tool may include AI models such as an LLM or other generative AI models that may understand code language and be capable of deciphering specific characteristics of code sentences, sections, portions, and the like that would correspond to the integration with the computing service. For example, a name of an API accessible over a network, network address, and the like may be used by the integrations when executing calls to the computing service for processing. Thus, the LLM may parse the code to identify the code relevant to the integrations, and determine the integration through comparison to different versions of code, as well as the tasks, endpoints, and the like that use the versions in the code. The LLM may also infer the integration using calls between the entity and the service provider's platform, or the tool may receive a network address or the like for the entity's computer system to send and receive those calls for parsing.

For example, the AI system of the service provider may include one or more AI models, such as LLMs, ML models, NNs, and/or the like, to converse with merchants, service provider agents assisting the merchant with code integrations, and/or other users to determine a personalized and recommended code integration for computing services of the service provider with the software platform of the merchant. These AI models of the AI system may include generative pretrained transformers (GPTs) including ChatGPT™, Bidirectional Encoder Representations from Transformers (BERT), a Robustly Optimized BERT Approach (RoBERTa), and the like, as well as general purpose or domain specific LLMs. The AI system of the service provider may also include other types of LLMs and/or generative AIs, such as one specifically configured for code generation and software integrations.

Training of the AI model (e.g., LLM or other generative AI) may be performed using background data for the service provider and/or merchants of the service provider, such as the available computing services and/or products of the service provider, previous code integrations, updates or changes to code and code integrations, legacy code updates to new code, and the like. Further, past onboarding experiences, experience feedback, and/or use or engagement with computing services, products, and the like of the service provider by merchants may be used. During training of the AI model, the AI model may be trained to make predictions and recommendations of computing code and/or code changes for code integrations. These recommendations may be used to determine new integrations, such as where the merchant may not previously have integrated a computing service with their software platform, as well as update and/or upgrade existing integrations from legacy code and/or code snippets, components, statements, endpoints, etc., to new, more optimized, and/or more efficient integrations and code.

Once trained, the AI model may be deployed to facilitate the onboarding of new merchant customers and the migration of existing merchant customers through automated code generation and development. The AI model may be prompted through one or more application programming interface (API) calls, such as through one-shot prompting, few-shot prompting, and/or the like, to generate and/or configure code for a code integration of a computing service with a software platform. For implementations where LLMs/generative AI is used, prompting may also be performed based on multiple input tokens for LLM processing that may be generated for subsets of the data. For example, where the data to be provided to an LLM of the AI system meets or exceeds a maximum data size or capacity, such as when the LLM is prompted in a conversational manner and the text or characters meets or exceeds the threshold, the data may be split into different subsets or groups corresponding to these tokens and the token limits of the LLM. To prompt the LLM, the selected data may be provided to the LLM with an LLM prompt, such as a statement question, query, request, and/or the like, which may provide an instruction to the LLM with examples or information for executing those instructions and returning a result. Prompt engineering may be performed to create one or more prompt templates that are optimized for best results and return of executable computing code for code integration detection and/or transformation.

These tasks and operations require the merchant or other entity to upload data files for the code, process requests and responses, and/or analyze call structure and content. This may correspond to a “logged out” user, entity, or merchant account because the user or entity may not be required to have an account with the service provider to perform integration detection. However, in a “logged-in” user, merchant, or other entity context, an account associated with the entity may be used to determine the integration of the entity's software platform with the service provider's software platform. In such a context, a history of requests, calls, computing services and/or their APIs called, and the like may be used to determine which integration the entity has used. The calls, such as API request/response calls, may also be established for the entity's account from past data processing requests, such as API requests or other calls to an API used for card processing and payment that were requested and performed on behalf of the entity. Further, the entity may use their account to directly select an integration, which would indicate the version of the integration at that time, or the entity may have used or downloaded code for a certain version that was available at a past time. As such, the entity's account may provide information indicating the version, type, structure, or the other parameter of the entity's code integration with the computing service of the service provider. With the account information, the tool and/or digital platform may map out and recommend an optimal implementation and migration path for their code integrations for the recommended code uses and/or upgrades.

The second tool of the digital platform for a code transformation assistant may provide assistance, instructions, and code to migrate the previous version of the computing code for the entity's code integration to a newest, most recent, recommended, or most used/common version of that code. The code transformation assistance may utilize an LLM or other generative AI of the AI system, as well as one or more other AI models or engines provided by the service provider's AI system, to process a prompt, such as a natural language question, that requests creation and/or transformation of code to a particular version, and generate code usable by the entity for the code integration. In this regard, an LLM used by the second tool from the AI system may be prompted with the templates, guides, samples of the target code for the version of the code to be generated, as well as the previous or past code of the entity being used for the code integration. The LLM may process the prompt and may provide output code for the entity to implement for migrating to the desired version of the code, integration, computing service, APIs, or the like.

The LLM of the AI system may then generate the code and/or code snippets, samples, classes, API configurations, and the like through intelligent processing using the trained layers, neurons, trees and/or branches, clusters, and/or other ML process. This may be based on training from a set of documents, samples, and/or the like. The output of the LLM may therefore correspond to a code file, section, snippet, or data package, which may be output and/or transmitted to the code transformation assistant for code configuration, writing, reviewing, and/or testing. The merchant may also specify particular API configurations and endpoints for use, which may include migration from legacy API configurations and endpoints to new ones that facilitate improved performance.

The code transformation assistant may provide the code as new executable instructions designated to replace or be implemented to replace the existing code such that the previous code does not need to be modified, rewritten, or otherwise changed by the entity. Therefore, the code provided by the code transformation assistant may reduce human error and/or manual efforts to update and change code, and may further make the code and corresponding components, systems, and applications of the entity's software platform and/or computer system compatible with the latest versions of the same or similar for the service provider. Further, the code transformation assistant may provide information associated with best practices of different entities for proper software platform integration with the service provider, as well as practices for adaptability, performance and security. When being used in a logged-in user/account context, the entity may also test code and code implementations, receive mappings to existing code and/or previously used or executed calls and other integrations, and the like.

As such, the service provider may provide merchants and other entities that may be customers or other serviced users with an AI system for faster, more efficient, and more accurate (e.g., less error-prone or with fewer coding errors) code integration. The AI system may leverage and utilize specifically trained generative AI models, such as LLMs, as well as ML models and techniques for understanding and determining code integrations existing in software platforms and architectures of those entities. A digital platform may be provided with one or more UIs where an entity may access the tools and components for more convenient and personalized computing service code integrations for their software platforms, thereby realizing the full capabilities of both platforms when coordinated together for data processing and exchange. The AI system may remove or limit the manual efforts for code development, and may further improve computing system efficiency through execution of newly generated code in place of updated code or recoding of old software systems and components. As such, the AI system may enable different software platforms to perform coordinated data communications and processing in a more optimized manner.

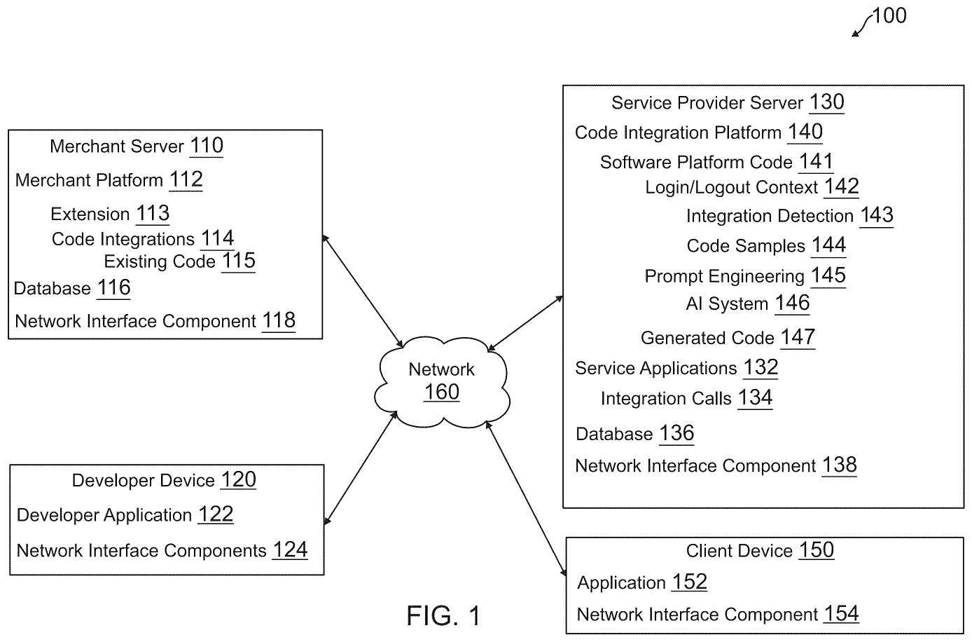

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, and/or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a merchant server 110, developer device 120, a service provider server 130, and a client device 150 in communication over a network 160. Merchant server 110 may be utilized by a merchant or other user to provide a merchant platform 112 over network 160 to client device 150. Service provider server 130 may provide various data, operations, and other functions over network 160 to provide services to merchants, users, and computing devices. In this regard, merchant server 110 may be integrated to be used with computing services of service provider server 130 by a developer or other user using developer device 120. Service provider server 130 may provide a code recommendation and generation system whereby a customer entity, such as a merchant or developer using developer device 120, may be recommended code integrations that may be performed, updated, or migrated to from the existing code integration used by merchant server 110. The code integrations may enable merchant server 110 to interface with service provider server 130 in a faster and more optimized manner for computing service usage. Once integrated with those computing services, merchant server 110 may provide a merchant sales platform to consumers or other users, such as a consumer that may use client device 150 to purchase items for sale via merchant server 110 using a transaction processor of service provider server 130.

Merchant server 110, developer device 120, service provider server 130, and client device 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Merchant server 110 may be maintained, for example, by a merchant that may utilize merchant platform 112 to provide products to users, such as items and services for sale, which may be browsed and purchased through an online digital platform and via computing devices including client device 150. In this regard, merchant server 110 may provide merchant platform 112 through a native software application and/or website and browser applications. Merchant platform 112 may offer products to users, such as items and services for sale, which may utilize the computing services of service provider server 130 through computing code integrations. Merchant server 110 may provide merchant platform 112 to client device 150 for engagement with the merchant's products and use of integrated computing services, as discussed herein. In one example, merchant server 110 may be provided by a merchant or multiple merchants including a merchant marketplace provider that allows multiple merchants to offer products for sale. However, in other embodiments, merchant server 110 may correspond to another type of entity that may have and/or utilize a software platform accessible via a native software application and/or a browser application of the client devices for users to access and view data, as well as engage with integrated computing services of service provider server 130.

Merchant server 110 of FIG. 1 includes and/or is associated with merchant platform 112, a database 116, and a network interface component 118, implementations of which are discussed further below. The merchant platform 112 may correspond to executable processes, procedures, and/or applications with associated hardware. In other embodiments, merchant server 110 may include additional or different modules having specialized hardware and/or software as required.

Merchant platform 112 may correspond to one or more processes to execute software modules and associated components of merchant server 110 to provide features, services, and other operations by a merchant for customers, which may include merchant sales operations, POS device processing and/or operations, online merchant marketplaces, sales and inventory services, and the like. For example, merchant platform 112 may correspond to a software platform where the computing services of service provider server 130 are offered to and/or available for use by merchant's customers via one or more integrations of computing code that executes calls, data processing operations, data transformations, and the like for data processing with service provider server 130. As such in some embodiments, the computing services of service provider server 130 may have previously been implemented and integrated with merchant platform 112, or may be integrated with merchant platform 112 for processes including merchant sales, inventory, return or exchange, risk analysis, and other services required during the course of their business and sales, such as to provide, market, and/or sell products, services, and other items to customers and/or assist customers with purchases.

In this regard, merchant platform 112 may correspond to a software platform configured for use by one or more merchants for the sale of products, goods, services, and/or other items to users. The software platform, which may include one or more applications, executable processes, code, and the like, may be provided to users through resident or native device applications, websites and web browsers, and the like. For example, merchant platform 112 may provide applications, websites, resources, and data based on the account and/or computing services enabled by service provider server 130 for the merchant. Merchant platform 112 may provide and/or process items for sale by a merchant to a user interacting with merchant server 110 via client device 150 (e.g., via a POS device, the website, mobile application, and/or another merchant marketplace platform). In certain examples, merchant platform 112 may be accessible over the Internet and provide processes for engaging in sales with customers and other users of a merchant over network 160.

In some embodiments, merchant platform 112 may correspond to and/or be used to configure a checkout application at a physical merchant location, such as the application(s) of a point-of-sale (POS) device used to provide sales at physical locations. For example, merchant platform 112 may be used to establish a transaction once a user/employee associated with merchant server 110 has selected one or more items for purchase and/or entered the item(s) to the transaction for processing. Once a payment amount is determined for the item(s) to be purchased by the user, merchant platform 112 may request payment for the transaction. Payment may be provided using electronic transaction processing services enabled and/or provided by service provider server 130 after incorporating and/or integrating computing services of service provider server 130, as discussed herein. In this regard, an extension 113 may be provided by service provider server 130 and may provide an on-device and/or device-side application, application plug-in or extension, or other component to utilize code integration processes of service provider server 130 for implementing and/or updating code integrations, such as an integration detection component for parsing code files or packages and/or a code transformation component for generating code for software integrations.

For example, in one embodiment, service provider server 130 may correspond to a transaction processor, where merchant platform 112 may utilize an electronic payment processing service to process payments with customers, such as a payment with a user of client device 150. As such, code integrations 114 may provide a process by which the payment processing computing service of service provider server 130 may be used on merchant platform 112 instead of redirecting the user externally to complete a payment. Thus, payment may be received from a user and may be processed using service provider server 130 through merchant platform 112. Code integrations 114 may also be generated, developed, implemented, and/or updated/replaced for other types of computing service integrations, such as messaging, account, social networking, media viewing or sharing, and the like. With payments, one of code integrations 114 may, after receipt of payment and/or confirmation of the payment, process the completed payment internally to arrange for shipping or other delivery of the merchant item, which may notify the merchant associated with merchant server 110 and/or corresponding user.

In some embodiments, merchant platform 112 may be used to host, provide, and/or access and maintain a website of the merchant, a web-based application, and/or the like, which may also be configured based on computing services provided by service provider server 130. The website may be operated, hosted, updated, and provided to end user devices and other systems or servers. The website may correspond to a hosted website having webpages that may include parent and child webpages where customers and service providers may browse items and other services provided by a corresponding merchant, engage in electronic transaction processing, provide customer support and feedback, and the like. The website may be provided through one or more webpages having of Hypertext Markup Language (HTML) code, Extensible Markup Language (XML) code, JavaScript code, and/or Cascading Style Sheets (CSS). In other embodiments, merchant platform 112 may provide data for an application that may be installed on client devices of users and used to access the merchant's data, marketplace, items, and the like, as well as use the computing services of service provider server 130 through such application.

Merchant platform 112 may be provided using computing code that include code integrations 114. The computing code may correspond to written and/or generated computer code, snippets or portions, files, data packages, resources, APIs and endpoints, and the like that may be used during data calls and platform provision to different client devices of users. Code integrations 114 may be generated using and/or parsed, analyzed, or processed after implementation by extension 113 for any updates, migrations to new APIs, applications, platforms, and the like, or otherwise updated and/or replaced. Code integrations 114 may be implemented using computer code that provides processes to interface with service provider server 130 or corresponding API, endpoint, resource, or the like for computing service usage. As such, code integrations 114 may include code parameters or properties, including a code language, specifications, code packages or lines of executable code, and the like, which may be specified in code files, API specifications, SDDs, and the like. Website data for the website, as well as the aforementioned applications and application data, may be configured using code intelligently generated by service provider server 130, for example, using installed and/or configured code snippets, code packages, SDKs and SDK operations, APIs and endpoints, and the like.

The implemented code for the code integrations of merchant platform 112 with service provider server 130 may correspond to existing code 115 for the use of and/or interfacing with computing services of service provider server 130 on or with merchant platform 112. For example, website data may include HTML code with for API calls to APIs associated with service applications 132 of service provider server 130. Existing code 115 may be configured for code integrations 114 at a past time or event, such as during an onboarding of the merchant with the service provider for service usage. Existing code 115 may also or instead be associated with native application data for one or more applications on client device 150. As such, existing code 115 may correspond specifically to those integrations with merchant platform 112. However, existing code 115 may be required to be updated to newer and/or more optimized specifications, such as through code migrations to new platforms, services, and/or executable code, which may be provided through new code received from service provider server 130 from an AI system (e.g., an LLM response or output) based on processing existing code 115 and new, changed, or updated computer code for code integrations 114 that may be been changed since existing code 115 was implemented. As such, the new code may be generated by prompting an LLM, as discussed herein, based on the code configurations, specifications, SDDs, and the like for merchant platform 112.

In this regard, service provider server 130 may streamline code integration and migration services for code implementation and updates using extension 113, such as by parsing for code integrations 114 using existing code 115. The application and/or website may further be updated when or after the merchant is onboarded and/or implements code in order to update the computing service capabilities of service provider server 130 with the application and/or website (e.g., payment functionalities, as well as other integrated operations and/or SDKs). As such, the merchant may provide merchant platform 112 via a website, application, and/or the like to end users, which may be configured to use the computing services, SDKs and SDK operations, APIs and endpoints, and the like provided by service provider server 130.

Merchant platform 112 may be accessible by users via a general browser application and/or general, native, and/or local mobile application configured to retrieve, present, and communicate information over the Internet (e.g., utilize resources on the World Wide Web) or a private network. For example, merchant platform 112 may correspond to a website accessible via a web browser, which may send and receive information over network 160, including retrieving website information (e.g., a website for an email provider or other messaging service), presenting the website information to the user, and/or communicating information to the website. Merchant platform 112 may instead correspond to application data accessible via a dedicated software application provided by the merchant or other entity. Merchant platform 112 may be associated with digital payment accounts, account information, user financial information, and/or transaction histories, which may be associated with electronic transaction processing services provided by service provider server 130 for merchants.

Merchant server 110 may further include or have access to database 116, which may correspond to different types of data storage and components including cloud computing storage nodes, remote data stores and database systems, distributed database systems over network 160, and the like used to store various applications and data. Database 116 may include, for example, identifiers such as operating system registry entries, cookies associated with merchant platform 112 and/or other applications, identifiers associated with hardware of merchant server 110, and/or other appropriate identifiers, such as identifiers used for payment/user/device authentication or identification, which may be communicated as identifying the merchant and/or merchant server 110 to service provider server 130.

Merchant server 110 includes at least one network interface component 118 adapted to communicate with developer device 120, service provider server 130, client device 150, and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Developer device 120 may be implemented as a communication device that may utilize appropriate hardware and software configured for wired and/or wireless communication with merchant server 110 and service provider server 130 over network 160. For example, in one embodiment, developer device 120 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Developer device 120 of FIG. 1 includes and/or is associated with a developer application 122 and a network interface component 124, implementations of which are discussed further below. The developer application 122 may correspond to executable processes, procedures, and/or applications with associated hardware. In other embodiments, developer device 120 may include additional or different modules having specialized hardware and/or software as required.

Developer application 122 may correspond to one or more processes to execute software modules and associated components of developer device 120 that may be utilized by a merchant, code developer of the merchant, or other user associated with the merchant and engaging in developing and/or updating merchant platform 112. For example, a user may use developer application 122 to access the features, services, and platforms provided by service provider server 130 and migrate code integrations 114 from existing code 115 to new code generated by service provider server 130. Developer application 122 may be used for development of software platforms of the merchant and integration of the software platforms with the computing services provider by service provider server 130. For example, developer application 122 may correspond to a browser application or native software application that may be utilized to configure merchant platform 112 on merchant server 110 and/or access a code integration platform 140 on service provider server 130 for use with configuring merchant platform 112.

During use of developer application 122, one or more interfaces may be presented to a developer or other user of the merchant, which may be used to access and view a corresponding website or application of code integration platform 140 associated with service provider server 130. The interfaces may enable the developer to engage in development of merchant platform 112 and integration of computing services of service provider server 130 with merchant platform 112 via code integration platform 140 of service provider server 130. In this regard, the interfaces may display options, suggestions, recommendations, and/or other information from the digital platform and tools for code integration detection, transformation, and migration. Such dynamically configured code and presentations of data may include configurable and/or specifically generated code snippets, code packages, SDKs and SDK operations, APIs and endpoints, and the like that may provide executable operations to cause merchant platform 112 to interface with one or more of service applications 132 of service provider server 130 or other computing service.

Developer application 122 may correspond to a general browser application and/or general, native, and/or local device application configured to retrieve, present, and communicate information over the Internet (e.g., utilize resources on the World Wide Web) or a private network. For example, developer application 122 may correspond to a website accessible via a web browser, which may send and receive information over network 160, including retrieving website information (e.g., a website for an email provider or other messaging service), presenting the website information to the user, and/or communicating information to the website. Developer application 122 may correspond to application data accessible via a dedicated software application provided by the merchant or other entity. Developer application 122 may be associated with merchant accounts and account information for products of service provider server 130 used by the merchant and/or on merchant platform 112, account information, user financial information, and/or transaction histories, which may be associated with electronic transaction processing services provided by service provider server 130.

Developer device 120 includes at least one network interface component 124 adapted to communicate with merchant server 110, service provider server 130, and/or other devices and servers. In various embodiments, network interface component 124 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 130 may be maintained, for example, by an online service provider, which may provide computing services and operations via one or more digital platforms, applications, websites, and the like. Service provider server 130 may provide computing services to various entities, which may require onboarding for account and service usage. In one example, service provider server 130 may be provided by PAYPAL®, Inc. of San Jose, CA, USA. However, in other embodiments, service provider server 130 may be maintained by or include another type of service provider.

Service provider server 130 of FIG. 1 includes and/or is associated with code integration platform 140, service applications 132, a database 136, and a network interface component 138, implementations of which are discussed further below. Code integration platform 140 and service applications 132 may correspond to executable processes, procedures, and/or applications with associated hardware. In other embodiments, service provider server 130 may include additional or different modules having specialized hardware and/or software as required.

Code integration platform 140 may correspond to one or more processes to execute modules and associated specialized hardware of service provider server 130 to provide an AI platform that may utilize LLMs, generative AIs, and/or other ML models for automated code generation and migration from previous or existing code integrations on a software platform for merchant or other entity to new, more highly recommended, improved, or more compatible code integrations for the use of computing services associated with service applications 132 of service provider server 130. In this regard, code integration platform 140 may correspond to specialized hardware and/or software used by a merchant or other user associated with merchant server 110 to provide operations for code integration development and implementation on merchant platform 112, which may enable the use and/or interaction with the computing services of service provider server 130 available via service applications 132. For example, code integration platform 140 may receive code integration requests for integrating different software platforms with the computing services provided by service provider server 130. This may occur when a user associated with the merchant or other entity logs on to code integration platform 140 and/or an account with service provider server 130 and utilizes the platform's tools, user interfaces, and the like for integration recommendation and code development. Based on this request, code integration platform 140 may provide an AI engine to process code integration requests and generate computing code, such as new code that may be used for a new integration when no integration was previously used and/or a migration integration of legacy or previously used code of the software platform.

As such, code integration platform 140 may generate data for processing to determine code recommendations, new code samples or blocks of code, and the like. The AI-generated code, such as code that may result from prompting an LLM, may be provided in response to code integration requests, which may provide the requester, such as developer device 120, with computing code that facilitates integration of a software platform with computing services provided through service applications 132. In this regard, code integration requests may be processed to determine data that may be provided as input and for processing by an AI engine of AI system 146, such as data that may be used as an example or sample when prompting an LLM or another generative AI. This may include a login/logout context 142 that may provide the available data for the entity's software platform that may be usable by an LLM to perform code generation for a code integration between software application or systems. In this regard, login/logout context 142 may be based on how the entity provides their existing code for parsing and analyzing to determine code integration detections, as well as whether the entity has an account or otherwise requested that their code be analyzed for code integration recommendations and generation.

In this regard, login/logout context 142 may include legacy code integrations from data received from merchant server 110, including information for existing code 115 implemented on merchant platform 112. The data may also correspond to computer code for other merchant software platforms for past or legacy code integrations that may be available to the merchant and/or service provider server 130, as well as an integration detection 143 performed by code integration platform 140. Integration detection 143 may be performed by a first tool provided by code integration platform 140 for use with code recommendations, migrations, transformation, and the like, such as an integration detection tool. The first tool that performs integration detection 143 may correspond to an AI process by which source code files, packages, blocks, and the like are processed to determine a version or other identification of the origin of source code used for a software code integration between two platforms. Integration detection 143 may determine other identifying characteristics of that integration, such as the APIs called or interfaced with, the computing services used, the call or message structure or data, the request/response parameters, trust relationships (e.g., encryption keys, digital signatures, etc.), and/or other parameters of that integration for data processing.

In this regard, integration detection 143 may be performed by an AI system 146, such as an LLM or other ML process, model, or engine, AI system 146 that may be called based on prompts available to and/or configured by prompt engineering 145. In some embodiments, an LLM may be prompted to scan or parse through source code from one or more samples, sections, structures or the like, or the LLM may interface with a software system through an extension, connection, or the like. For example, one or more of AI models of AI system 146, such as an LLM, may be provided with authorization to scan or parse through the source code of merchant platform 112 using extension 113. Thereafter, the LLM may be prompted to identify the code integration using samples, templates, or other information that would indicate the code integration, and its corresponding version, being using in source code. For example, with API calls, call logs and call structures may be analyzed to determine a destination or recipient API, the name and/or version of the API, and the like, which may indicate which the use of the code integration, as well as the version that uses such code. Once detected, the LLM, or other AI model or component of AI system 146 trained for recommendation of code integration and/or upgrades to code integrations, may be used to determine a recommended practice or course for the entity to take when updating their code integrations.

Additionally, code samples 144 may be provided when performing integration detection 143 and/or when creating generated code 147 one or more code integrations that may be performed for the recommended, or other selected, code integration to be performed. In this regard, a second tool provided by code integration platform 140, such as a code transformation assistant tool, may provide capabilities and/or processes to create and/or generate new code, as well as transform, and/or migrate old code, to the code versions and other requirements of newer and/or more highly recommended software integrations, applications, and platforms. Legacy code integrations and/or code samples 144 may include code files for the merchant software platform (e.g., previous code files for legacy, past, and/or currently used code integrations, which may be designated for updating, upgrading, and/or migrating to newer code), SDDs, request payload samples or structures, contexts for code integrations and/or service usage, and the like. Code files may be provided directly, such as in one or more uploadable/downloadable files, a compressed file (e.g., a . zip file), and/or the like, or may be linked to a code repository platform (e.g., GITHUB®). The data may be processed to determine computing code (e.g., blocks, files, snippets, samples, etc.), SDKs, API endpoints for system integrations, and the like for integrating computing services with merchant platforms 112.

In implementations where AI systems 146 include LLMs and/or other generative AI systems, prompt engineering 145 may be performed to create one or more prompts that may be used to prompt AI system 146, such as to generate code. Prompt engineering 145 may be performed to generate prompts that cause AI system 146 to generate and/or provide source code for a code integration that is to be created, updated, and/or replaced for a software platform of an entity to interface with service applications 132. As such, prompt engineering may generate prompts that correspond to instructions, such as text instructions and/or API calls to AI system 146, that may be used with the data from the data to prompt AI system 146 and request LLM responses from AI system 146. For example, the instructions of a prompt may correspond to instructions to AI system 146 to generate code by using samples from the data, as well as the training and knowledge base of AI system 146, to determine code that may be used to integrate the computing services of service applications 132 with merchant platform 112. Prompt engineering 145 may include and/or be associated with prompting strategies that may be used to prompt AI system 146 through different questions, statements, calls, and the like (e.g., zero, one, and/or few-shot call prompting, question-and-answering prompting, chain-of-thought prompting, etc.).

Prompts may also correspond to different types of code to be generated, such as code for different types of services and/or processing flows for the computing service. For example, AI system 146 may have different token limits, such as a limit on data size, a number of characters in a text request and prompt, and the like, which may limit the amount of data provided through the data in a single request or call. As such, the data may be separated into different code sections and “tokens” based on the token limits and code sections or services to be generated for code integrations of services. These may include an authentication service, backend including order service and/or API service(s), one or more UIs, code dependencies on different resources or services, unit tests to verify other blocks of code, and the like.

AI system 146 may then be prompted to provide code based on the data and corresponding prompt. The prompts may be provided as templates, structures, generalized or specialized instructions, or the like, which may be utilized for the specific prompt and request being sent to AI system 146. Code integration platform 140 may train and utilize AI system 146 that execute one or more deep learning models, AI or ML models, NNs and/or deep NNs (DNNs), conversational AIs, and/or the like for general or specialized (e.g., domain-specific, such as code generation-specific) purpose language generation. AI system 146 may have trained layers based on training data and selected features or variables configured to generate conversation or dialogue with merchants during onboarding. For example, ML features or variables may correspond to individual pieces, properties, characteristics, and/or other inputs for an ML model and may be used to cause an output by that ML model once the ML model has been trained using data for those features from training data. AI system 146 may be used for language generation through deep learning or other ML models based on layers, nodes, branches, clusters, rules, and the like that are trained and optimized. As such, AI models may be trained and/or configured to provide a predictive output of responsive language and/or language generation, such as a text response and/or automatically generated computing code.

For example, AI system 146 may include DNNs, MLs, LLMs, generative AIs, and/or other AI models trained using training data having data records that have columns or other data representations and stored data values (e.g., in rows for the data tables having feature columns) for the features. When building AI system 146, training data may be used when training AI models to generate one or more classifiers and provide recommendations, predictions, and/or other outputs based on those classifications and an ML or NN model algorithm and architecture. The algorithm and architecture for the AI system 146 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, and/or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values include language generation. Thus, when the AI system 146 are used to perform a predictive analysis and output of language generation, the input data may provide a corresponding output based on the trained classifications.

Layers, branches, clusters, and/or the like of the AI system 146 may be trained by using training data associated with data records of interest, such as computing code, code specifications or development documents, API and API call structures or API specifications, previous code integrations, and the like. By providing training data, the nodes in the hidden layer may be trained (adjusted) such that an optimal output (e.g., a classification) is produced in the output layer based on the training data. By continuously providing different sets of training data and/or penalizing the AI system 146 when the outputs are incorrect, the AI system 146 (and specifically, the representations of the nodes in the hidden layer) may be trained (adjusted) to improve its performance in data classifications and predictions. Adjusting of the AI system 146 may include adjusting the weights associated with each node in the hidden layer.

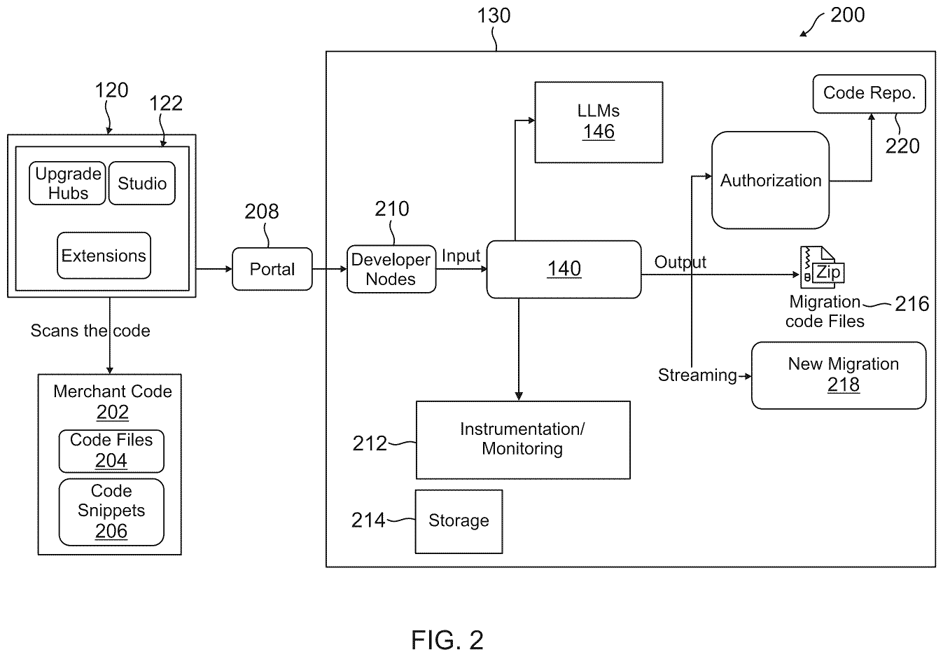

In implementations of AI systems 146 that include LLMs, the LLMs may provide responses to other outputs to prompting, which may include integration detection 143 and/or generated code 147. For example, AI system 146 may output generated code 147 during integration migrations and/or code transformations via one or more user interfaces presentable via user devices, on different computing platforms, and/or in different computing environments. For example, generated code 147 may be generated by AI system 146 at service provider server 130, where developer device 120 may be used to implement new and replacement code with or on merchant platform 112 of merchant server 110. Generated code 147 may be output by AI system 146 through creation of new code that replaces existing code 115 and may perform code integrations with service applications 132 to exchange integration calls 134 in a faster, more efficient, or more optimized manner. A chat session and/or chat assistant may assist with performing integration detection 143 and/or obtaining generated code 147, which may provide a live or automated agent to interface with AI system 146 and/or tools that utilize AI system 146 for the processes described herein. The operations for performing integrations detection 143 and/or creating generated code 147 for use with merchant platform 112 are discussed in further detail with regard to FIGS. 2A-4 below.

Service applications 132 may correspond to one or more processes to execute modules and associated specialized hardware of service provider server 130 to process a transaction and/or provide other computing services to users. For example, service applications 132 may be used to process payments and other services to one or more users, merchants, and/or other entities for transactions, where merchants may integrate use of one or more of service applications 132 through generation of generated code 147 by code integration platform 140. In this regard, service applications 132 may be used to send and receive payments, including those payments that may be enabled through the website and/or application corresponding to merchant platform 112 after integrations have been performed on merchant platform 112 with service applications 132 using code integration platform 140. As such, integration calls 134 may be exchanged once enabled through the code integrations, allowing for separate software platforms to interface. A payment account for use of these services may be accessed and/or used through a browser application and/or dedicated payment application, such a payment and/or digital wallet application. Service applications 132 may process payments and may provide transaction histories to merchant server 110 and/or another user's device or account for transaction authorization, approval, or denial of the transaction for placement and/or release of the funds, including transfer of the funds between accounts.

Further, service applications 132 may provide different computing services, including social networking, microblogging, media sharing, messaging, business and consumer platforms, etc. These computing services may be used by customers and users, such as through user devices, and may be implemented on different merchant platforms, websites, and/or applications. For example, merchant platform 112 may implement one or more of the computing services of service applications 132 and may call those services using those integrations through integration calls 134. Integration calls 134 may be used to process data with merchant platform 112 and provided requests and responses for data processing. For example, integration calls 134 may be utilized for processing payments for item sales on and/or with merchant platform 112.

Service applications 132 may provide additional features to service provider server 130. For example, service applications 132 may include security applications for implementing server-side security features, programmatic client applications for interfacing with appropriate application programming interfaces (APIs) over network 160, and/or other types of applications. Service applications 132 may contain software programs, executable by a processor, including one or more GUIs and the like, configured to provide an interface to the user when accessing service provider server 130, where the user or other users may interact with the GUI to view and communicate information more easily. Service applications 132 may include additional connection and/or communication applications, which may be utilized to communicate information to over network 160.

Additionally, service provider server 130 includes or may access database 136. Database 136 may store various identifiers associated with merchant server 110, developer device 120, and/or client device 150. Database 136 may also store account data, including payment instruments, financial information, account balances, and authentication credentials, as well as transaction processing histories and data for processed transactions. Database 136 may include information used during merchant onboarding. Although database 136 is shown as residing on service provider server 130 as a database, in other embodiments, other types of data storage and components may be used including cloud computing storage nodes, remote data stores and database systems, distributed database systems over network 160 and/or of a computing system associated with service provider server 130, and the like.

Service provider server 130 may include at least one network interface component 138 adapted to communicate merchant server 110, developer device 120, client device 150, and/or other devices and servers over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Client device 150 may be implemented as a computing device of a user, such as a consumer or a customer of a merchant associated with merchant server 110, and may utilize appropriate hardware and software configured for wired and/or wireless communication with merchant server 110 and/or service provider server 130. For example, client device 150 may be utilized by a consumer to access merchant platform 112 to browse items for sale and engage in electronic transaction processing. Client device 150 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly, such as those of a plurality of consumers engaging in shopping and purchasing from the merchant via merchant platform 112.

Client device 150 of FIG. 1 contains an application 152 and a network interface component 154. Application 152 may correspond to executable processes, procedures, and/or applications with associated hardware. In other embodiments, client device 150 may include additional or different modules having specialized hardware and/or software as required.

Application 152 may correspond to one or more processes to execute software modules and associated components of client device 150 to provide features, services, and other operations to a user, which may include accessing merchant platform 112 and/or engaging in use of computing services provided by service provider server 130 via merchant platform 112. In this regard, application 152 may correspond to software utilized by a user of client device 150 to access a website or application data (e.g., for a mobile application, rich Internet application, or resident/native software application) that may display one or more UIs that allow for interaction with merchant platform 112, for example, to browse items for sale, select and/or checkout for items, process transactions electronically (e.g., perform electronic transaction processing for items, send/receive payments, etc.), login to accounts, and/or receive receipts and transaction histories.

Thus, application 152 may display data for merchant platform 112 that allows the user to interact with merchant platform 112 via the UI(s) displaying data for the merchant's items for sale, offers, advertisements, and other information on merchant platform 112. Application 152 may allow the user to utilize and/or interact with the integrated computing services of service applications 132 on merchant platform 112 through code integrations 114. In various embodiments, application 152 may correspond to a general browser application configured to retrieve, present, and communicate information over the Internet (e.g., utilize resources on the World Wide Web) or a private network. However, in other embodiments, application 152 may include a native and dedicated application associated with merchant server 110, service provider server 130, and/or another entity that may access data for and/or present merchant platform 112 on client device 150.

Application 152 may be associated with account information, user financial information, and/or transaction histories for electronic transaction processing, including processing transactions using financial instrument or payment card data on merchant platform 112 using existing code 115 for integrated computing services, which may be updated by new code, as discussed herein. Application 152 may be utilized to enter, view, and/or process items the user wishes to purchase in a transaction, as well as perform peer-to-peer payments and transfers, using the integrated computing services. A payment may be requested to be made on merchant platform 112 using the integrated services, and application 152 may be used to specify user financial information, such as credit card data, bank account data, or other funding source data, as a payment instrument when providing payment information to service provider server 130. Additionally, application 152 may utilize a digital wallet associated with an account with a payment provider as the payment instrument, for example, through accessing a digital wallet or account of a user through entry of authentication credentials and/or by providing a data token that allows for processing using the account. Application 152 may receive a receipt or other information based on transaction processing of the transaction. In some embodiments, additional services may be provided via application 152, including social networking, media posting or sharing, microblogging, data browsing and searching, online shopping, and other services available through service provider server 130.

Client device 150 includes at least one network interface component 154 adapted to communicate with merchant server 110, developer device 120, service provider server 130, and/or another device or server. In various embodiments, network interface component 154 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIG. 2 is an exemplary computing environment 200 for computing code generation for code integrations of software platforms with computing services, according to an embodiment. Computing environment 200 may include components of service provider server 130 that may be utilized to determine code integrations existing on a computing platform and migrate, update or implement new code and/or replacement code to integration the computing platform with one or more computing services of service provider server 130, as discussed in reference to system 100 of FIG. 1. In this regard, developer device 120 may be used to access such resources, digital platforms, websites, applications, and the like to determine execute code for use by merchant platform 112.

Referring now to computing environment 200 of FIG. 2, an embodiment is shown of code integration platform 140 that may provide a digital platform accessible over a network, such as through a website and/or via a resident software application, which may provide a conversational AI and/or AI code generation service through the use and implementation of LLMs and/or other AI models and components. In computing environment 200, service provider server 130 includes code integration platform 140 accessible to developer device 120. In this regard, developer device 120 include developer application 122, which may be used to access, install, and/or connect to different tools and components of code integration platform 140. For example, developer application 122 may include upgrade hubs for code integrations, a developer studio where code developers may develop computer source code for different processes and tasks including applications and software applications, and/or extensions that may be installed with one or more applications, such as a browser application, to enable interactions with code integration platform 140.

Developer device 120 may be utilized to develop code for merchant server 110, where merchant server 110 may provide a software platform to customers and/or consumers, such as through a website or application where users may browse and purchase items for sale. In order to provide this software platform, merchant code 202 may be used as source code executable by processors of devices, and which may include computer code for integrations with computing services provided through service applications 132 of service provider server 130. Merchant code 202 may be associated with code files 204 and code snippets 206, each of which may be parsed and/or analyzed for code integration detection, as well as modified, replaced, and/or removed for migration of previous, existing, or old versions of the computer code and/or code dependencies for code integrations to current and/or new code versions.

In this regard, a portal 208 may be accessed by developer device 120 in order to interface with and request/receive data from code integration platform 140 via developer nodes 210. Portal 208 may correspond to a network component of service provider server 130 and configured to provide access to developer nodes 210 where developers may access, view, request generation of and/or generate (e.g., by entering or uploading code and/or editing generation or previous/available code) computer code for code integrations. Code integration platform 140 may then provide access to and/or interface with to provide different tools and components for code integration services. For example, with existing code integrations, an integration detection process or service may be provided through a code integration detection and recommendation tool. Code integration platform 140 may utilize the tool to parse and/or analyze merchant code 202. In some embodiments, merchant code 202 may be uploaded and/or provided to code integration platform 140 by developer device 120, such as by uploading or otherwise providing code files 204 and/or code snippets 206 to code integration platform 140 on or via developer nodes 210. However, in other embodiments, one of the extensions of developer application 122, such as extension 113 that may also be installed on or permitted access to merchant server 110 and/or existing code 115 on merchant server 110, may provide access to merchant code 202 and/or may permit code integration platform 140 to scan merchant code 202. In this regard, merchant code 202 may be parsed and processed to identify code integrations that are currently used and/or require an update or replacement on merchant server 110.

Code integration platform 140 may further provide a service by which the detected code integrations are processed to determine any upgrades, updates, or recommended changes to versions of existing code integrations in order to utilize a new or different versions of the code integrations. As such, code integration platform 140 may interface with AI system 146 for integration recommendations and source code generation, an instrumentation/monitoring 212 for tracking and/or monitoring API calls and the like to performing integration detection for a login context, a storage 214 for storing account and/or software platform usage, calls, and/or interactions, and new and/or target code versions or samples usable by one or more AI models of AI system 146 to generate code procedurally and automatically without human intervention. These operations may be provided by a code transformation tool, and may access data for new or target data from migration code file 216, new migrations 218 that have recently been performed, and/or a code repository 220.

In this regard, code integration platform 140 may utilize one or more of AI system 146 via calls and prompting for code generation. AI system 146 may be prompted based on merchant code 202 and other provided data with one or more prompts configured and designed by or from prompt engineering 145 in system 100. The prompts may include instructions for AI system 146 to provide code generated for a code integration that would implement the latest or selected version of a code integration on the software platform of the merchant or other entity. For example, when migrating different integrations of computing services of a service provider with a software platform of a merchant, old, outdated, or retired versions of code integrations may utilize code, code formats, endpoints, APIs, and the like that have been changed or updated in a most recent, recommended, or selected version. This may have been done for security, efficiency, speed (e.g., processing power or network latency), or other developer reasons and rationales.

As such, code integration platform 140 may correspond to an implementation of one or more tools to interface with and use AI system 146 and/or one or more AI models of AI system 146, such as for generative AI services. These AI services are used for code generation provided by code integration platform 140. AI system 146 may include and/or provide access to one or more AI models trained for outputting code integrations by procedurally generating computing code for code integrations. These AI models may include LLMs for language processing and/or generative AI services. As such, AI system 146 may be trained for generating computing code for newly implementing a computing service through a code integration and/or migrating a previous code integration of a computing service with a software platform. The code generated for the integration may correspond to new code, APIs, and/or other code specifications and components for code integrations as specified by a version of that integration. Code integration platform 140 may receive a prompt having merchant code 202 and/or may access a storage for code data including source code, different versions of code integrations, SDDs, data files for computing code (e.g., code blocks, snippets, documents, etc.), and the like. In some embodiments, the code provided to AI system 146 may include monitored or historical calls, interactions, and/or code integrations performed by the merchant, which may be stored by storage 214 after detection and/or recording by instrumentation/monitoring 212.

Further, the prompt may include examples of the target or desired version of the code integration for transformation, as well as an instruction to convert or transform the existing code used for the code integration to the new or target version of the code. In this regard, the target, desired, or new version of the code integration may include version information, samples, templates, and the like from migration code files 216, new migrations 218, and the like. Code repository 220 may further store code files, snippets, and other data for existing code integrations and/or versions of new code integrations and the like. The instructions may therefore cause AI system 146 to generate code from the provided examples such that, when a merchant requests a code migration, new code, APIs, computing environments or systems, and the like may be generated. As such, the merchant may provide different data files, packages, links, and the like for legacy computing code of legacy integrations, source code for software platforms, and the like. Output of this process may correspond to code automatically generated by AI system 146 based on training data and a knowledge base, as well as code analysis and predictive AI generation using one or more deep learning models or the like. For example, an output may correspond to LLM responses having generated code for new code integrations, which may be provided as code blocks, snippets, files, and/or the like. Code generated by AI system 146 may be generated in block and/or sections such that multiple outputs for different code sections may be combined into a code package for review and/or use by the merchant. The generated code may be provided via developer nodes 210 and different computing systems and/or environments for developer device 120 to access, utilize, and/or implement. Further, code repository 220 may receive the code and may enable the developer to view, test, change, and/or utilize the code.

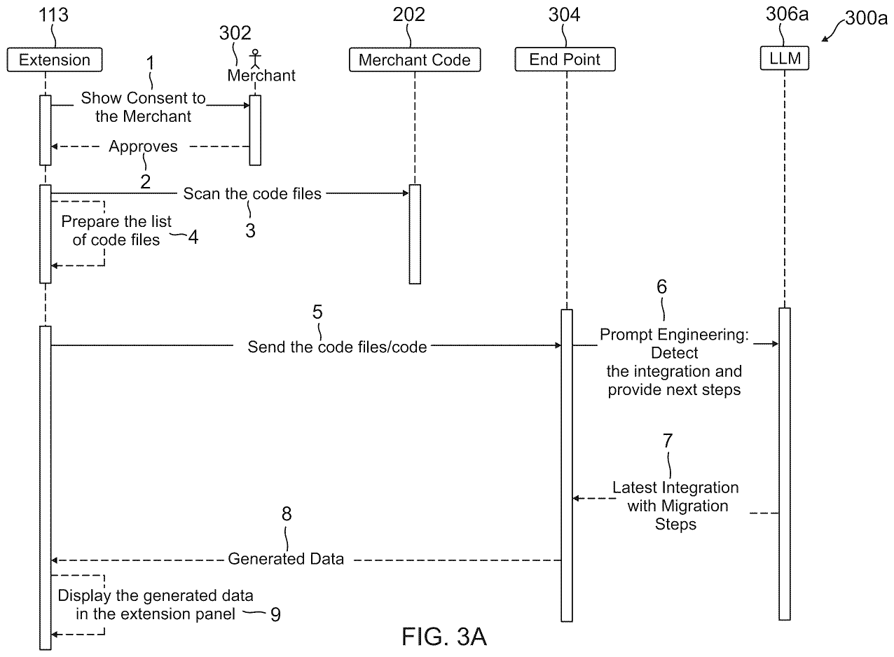

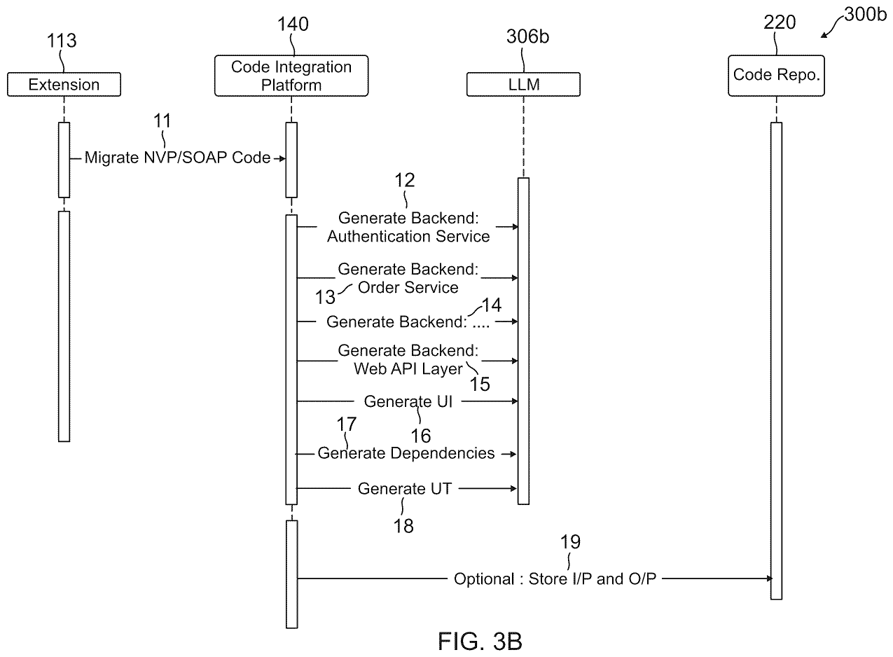

FIGS. 3A and 3B are exemplary diagrams 300a and 300b of calls between different systems and services when generating computing code for computing service integrations of software platforms, according to various embodiments. Diagrams 300a and 300b display different calls exchanged between components, such as APIs, of software platforms when executing data processing operations and other interactions. As such, the calls may be exchanged between devices, servers, systems, and components shown in reference to system 100 of FIG. 1 and computing environment 200 of FIG. 2. For example, calls 1-9 in diagram 300a and/or calls 11-19 in diagram 300b may be exchanged and processed during and/or based on the use of code integration platform 140 of service provider server 130, which may be used by different users of merchants or other entities when performing code integrations of, as well as migrations of existing or previous code to, current or recommended versions of the code for computing service software platforms. Diagrams 300a and 300b represent a request from an extension 113, such as developer device 120, of a merchant that may be processed to provide computing code for migrating computing code of the merchant's software platform to new APIs or other new or updated computing service components and code, although other types of integrations and corresponding computing code may similarly be generated using the calls and integrations shown in diagrams 300a and 300b.

In diagram 300a, a merchant device 302 request is received from merchant device 302 that merchant code 202 is to be updated and/or replaced, in whole or in part, with executable computer code for code integrations that integrate a software platform of merchant device 302 with a computing service of a service provider. In this regard, the merchant may be required to consent to code analysis and parsing to ensure any data privacy and/or security requirements are met by the merchant and service provider. As such, extension 113 or merchant device 302 and/or with a corresponding merchant system may provide a consent interface that requests that the merchant corresponding merchant device 302, or other authorized user consent to code and data parsing and analysis at a call 1. This may be done by extension 113 by calling the device or UI to present the consent interface. At a call 2, merchant device 302 provides a response received via UI presented to approve the consent request and consent to having merchant code 202 analyzed for migrating existing code integrations to new and/or updated code integrations. The consent may be logged by extension 113, as well at provided to the service provider or another entity involved in data privacy and security management and consent authorization and enforcement.

At a call 3, extension 113 scans merchant code 202 including one or more code files, snippets, or the like having the computer code of the merchant. Scanning of the computer code may utilize one or more processes trained and/or configured to determine portions of merchant code containing the code integrations, which may be used to determine a version or other identification of the code integration. As such, extension 113 may perform analyses, comparisons, and/or identifications of particular uses of code language, dependencies, and the like. At a call 4, the code files and/or code is prepared in a list or other organization for determination of the code integration by LLM 306a and recommendation of integration updates and migrations. LLM 306a may correspond to one of the AI models (e.g., one of one or more LLMs) of and/or provided access by AI system 146. Extension 113 may generate that list and, at a call 5, sends the code files and/or code in the list to an endpoint 304 of code integration platform 140 for the platforms tool that performs code integration detections and recommendations. As such, endpoint 304 may correspond to a call address or identifier that is a designated recipient of code for analysis by LLM 306a.

Endpoint 304, at a call 6, calls LLM 306a with a prompt from prompt engineering, that requests LLM 306a to detect the existing code integration, such as the version or other information of the origin of source code for the code integration that currently is used by and implemented with the software platform. The prompt may correspond to a call with instructions for detecting the integration from merchant code 202, and may be accompanied by the integration code from merchant code 202 sent by extension 113. LLM 306a may analyze the provided code using the samples provided, knowledge base, and generalized/specialized model training to identify the integration and response, at a call 7, with a latest integration available for that code and the migration steps required to implement that integration.

LLM 306a may correspond to an endpoint of an LLM and/or generative AI service. Data may be accessed by LLM 306a to generate the response, including a code repository 220, such as an online resource where computing code may be stored and accessible for testing, review, recoding, and/or implementing with different platforms. The response at call 7 may therefore provide a text and/or natural language output instructing a merchant or other entity with the steps and/or procedures for migrating code integrations to latest versions. Endpoint 304 may receive the response, and at a step 8, provides any generated data, such as the migration instructions, to extension 113 for presentation to the merchant or other entity. Extension 113 may then interface the merchant, developer, or other entities device or server to present the received data via one or more user interfaces connectable or usable with the detection tool. At a step 9, the data for the new or recommended integration that was detected is shown to the merchant or other entity on their device. The data for the integration may also be provided to the code repository for access.

In diagram 300b, calls 11-19 may represent API calls between the different systems, components, applications, devices, and/or services shown in diagram 300. Calls 11-19 may be performed by code integration platform 140 when calling an LLM 306b based on input 222 to generate output 224, as shown in computing environment 200. For example, calls 11-19 represent a set of API calls to and/or from an API of code integration platform 140 that may be exchanged between different components during code generation for a code integration. For example, a code migration and/or code transformation tool of code integration platform 140 may receive and/or transmit the calls shown when communication with extension 113, LLM 306b, and code repository 220, which may be used for code generation. In particular, LLM 306b may be called to provide natural language and generative AI services for code generation. In this regard, calls 11-19 may be based on an input of source code samples and/or source code examples and templates for a software platform of an entity developing software code for that platform to integrate with another software platform.

Initially, extension 113 interacts with code integration platform 140 of service provider server 130 for a service provider via a call 11 to request migration of a code integration of the software platform with a past or old version of the code integration and those APIs, components, and/or parameters to usage of new APIs and other corresponding parameters and components. For example, a merchant using Simple Object Access Protocol (SOAP) APIs and code may desire to migrate those integrations to Representational State Transfer (REST) APIs and code. This may correspond to an upload or transmission of source code files, snippets, or other computer code and information usable for developing such computer code that may be associated with the integration. In some embodiments, extension 113 may also enable, authorize, and/or allow code integration platform 140 to access, scan, and/or parse source code of the software platform on one or more machines, which may occur during integration detection and/or code migration to determine samples of the computer code that may be usable to prompt an LLM for code generation.

Code integration platform 140 may receive the request and/or data for the existing and/or legacy code integration of the software platform. In some embodiments, the received data may correspond to legacy API code for a merchant's software platform with older, outdated, or retired SOAP APIs of the service provider and/or computing services. In some embodiments, code integration platform 140 may obtain code and code information, SDDs, and the like for the merchant's or other entity's software platform, applications, APIs, websites, etc. from a local cache or similar short-term storage used by integration detection to store data for code integrations detected on software platforms that have been analyzed. These databases may include code repository 220 that may store existing code and/or versions of code for use and reference. LLM 306b may correspond to an endpoint of an LLM and/or generative AI service. Code repository 220 may correspond to an online resource where computing code may be stored and accessible for testing, review, recoding, and/or implementing with different platforms.

During calls 12-18, code integration platform 140 may prompt LLM 306b in one or more calls and/or using one or more prompts and/or prompt instructions. As shown in diagram 300b, LLM 306b is prompted in parts (e.g., separate calls to LLM 306b) for generation of different code sections necessary for migrating the computing code of the merchant's software platform to usage of the new APIs for the computing service. This may include executing or transmitting individual API calls, or sets of API calls (e.g., for a few-shot prompting approach with LLM 306b) for each different code section to be generated by LLM 306b for the corresponding code integration. For example, LLM 306b may be prompted by code integration platform 140 to generate computing code to integrate with APIs and/or execute API calls needed for a backend authentication service at a call 12, a backend order service at a call 13, a backend (...) at call 14, a backend web API layer at a call 15, one or more UIs at a call 16, code dependencies at a call 17, and/or unit tests at a call 18.

For example, for call 12, authentication service code that adheres to a provided sample authentication code (e.g., for a specific authentication process and/or system), including the handling of the access token and the creation of a background process to check its validity, may be generated through the calls to LLM 306b. For call 13, the migrated code for a particular “order” operation, such as a checkout and ordering operation for a merchant, or other executable operation using one or more APIs of the computing service and/or application may be generated. LLM 306b may generate code in response to call 13 that may create an order with the API for the ordering and/or checkout framework and HTTP requests. LLM 306b, for call 15, may generate new or migrated code for the backed ordering and/or checkout system based on the provided context and mapping rules. For example, the migrated code for a checkout operation using the corresponding APIs may be generated and the code may use a library to make HTTP or other requests, as well as read the necessary environment variables for credentials. When proceeding to call 16 for UI code generation, LLM 306b may be called to generate UI code that integrates the SDK for the checkout process in one or more UIs. For example, the code may interact with the backend API endpoints set up and may create a checkout page or the like with an SDK script.

For call 17, LLM 306b may be prompted to generate a dependencies file for the code, such as a JSON package that includes all the dependencies needed for the backend code, such as dependencies on different components of the software system (e.g., libraries, frameworks, modules, APIs, services, etc.) that may be installed upon running the JSON package or the like. Finally, call 18 may request that LLM 306b generate unit tests, as well as any additional libraries for testing, of the code and dependencies generated by LLM 306b and/or utilized during code integration. As such, calls 12-18 may be performed to call LLM 306b by code integration platform 140 in parts to generate the corresponding code section. This process may be performed in order to comply with the corresponding token limit of LLM 306b, whereby the full code required for the integration may instead by generated in parts by calling LLM 306b to generate a code section corresponding to each of calls 12-18. This allows for generation of a specific section of code, which may be done while complying with the token limit of LLM 306b, and the code sections may then be combined, stitched together, or otherwise packaged.

LLM 306b may respond with the corresponding code, which may be packaged into a data package and/or container. For example, code integration platform 140 may combine, stitch together, or otherwise package each code section into a single code package or file that may be executable and/or utilized to integrate code and/or upgrade/migrate existing code for computing service usage on a merchant platform. Once packaged, code integration platform 140 may then store the data package with a data store 306 for access, such as by storing the input/payload and the output/payload from prompting LLM 306b and receiving responses from the LLM 306b via a call 19. The merchant may then access data store 306 to obtain the code, as well as upload to a different platform and/or environment for review, testing, and the like.

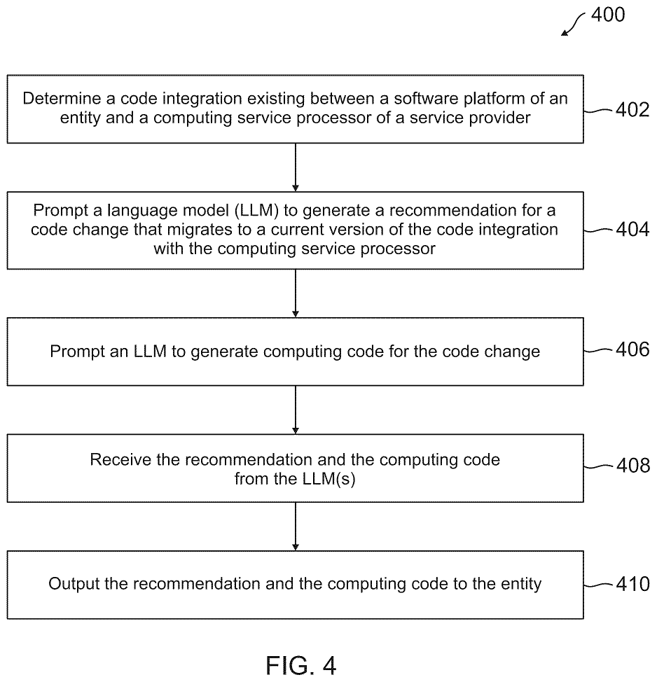

FIG. 4 is a flowchart 400 for automated code generation for updating software platform integrations with computing services, according to an embodiment. For example, flowchart 400 may be performed by code integration platform 140 based on code integration requests. In this regard, code integration platform 140 may receive a request from developer application 122 on developer device 120 to identify code integrations 114 of merchant platform 112 on merchant server 110 using integration detection 143. Once identified from existing code 115, that code may be changed or replaced using AI system 146 using generated code 147, which may facilitate the use of new APIs, endpoints, and other components of service applications 132 on service provider server 130 so that corresponding computing services may be provided through merchant platform 112. Note that one or more steps, processes, and methods described herein of flowchart 400 may be omitted, performed in a different sequence, or combined as desired or appropriate.

At step 402 of flowchart 400, a code integration existing between a software platform of an entity and a computing service processor of a service provider is determined. For example, in system 100 of FIG. 1, merchant server 110 may include code integrations 114 in existing code 115 that integrate and allow the use of a computing service provided by service provider server 130 on merchant platform 112. Code integrations 114 therefore allow the computing services of service provider server 130 to be provided on other separate and/or third-party platforms. As such, computer code and other merchant data, software platform data, code, and/or code requirements (e.g., capabilities, specifications, SDDs, etc.) may be parsed from merchant platform code integration.

Service provider server 130 may receive such data as a request with data for an input to AI system 146, where a first LLM of AI system 146 may be prompted to process the input and identify one or more of code integrations 114. This may correspond to a logout context or logged out user, entity, or account context, which does not require the requester to be identified and/or have a corresponding account with the service provider. However, in a login context or a logged in user, entity, or account context, the account of the requested may be used by the first LLM or another AI process, model, or engine based on the previous usage of APIs, endpoint, and other components of a computing service for computing service integrations with merchant platform 112. For example, one of code integrations 114 may utilize an older API of service applications 132, which may require migration to REST APIs, and therefore the integration may be identified by API calls made to the older API. As such, integration detection 143 allows for identification of code integrations 114 so that new and replacement code for those code integrations may be created for streamlined and efficient software platform integrations and uses. An additional tool using the first or a second LLM may then generate and provide code recommendations, snippets, packages, files, written code changes, and/or other executable computing code and information for the code migrations to newer, more recommended, or otherwise preferred or selected code integration versions or other option for the available code integrations for a particular computing service and/or task.

At step 404, an LLM is prompted to generate a recommendation for a code change that migrates to a current version of the code integration with the computing service processor. The LLM may correspond to a first LLM of AI system 146 trained for code integration detection. In this regard, computer code and other data for code integrations 114, such as executed calls, computer or network logs, code development documents, and other similar data for merchant platform 112 may be determined and utilized for LLM prompting for the recommendation. This may include prompting the LLM to identify code integrations 114 from existing code 115, and further determine whether code integrations 114 can and/or should be updated by migrating, such as by replacing, existing code 115 with generated code 147. As such, the first LLM may be prompted to perform integration detection 143.

To perform integration detection 143, the first LLM may be prompted with existing code 115 of merchant platform 112, as well as a sample, identifying content or characteristics, and/or other data for one or more different versions of code integrations 114. The data for existing code 115 may include information that allows for code to be written, developed, and/or generated for merchant platform 112 when integrating the computing services provided by service applications 132 with merchant platform 112, which may include code files or snippets of existing code 115, as well as other documents and information needed to integration merchant platform 112 with service applications 132 to exchange integration calls 134. To prompt the first LLM perform integration detection 143 and/or the same or another LLM to generate code, samples, files, and the like from existing code and/or legacy code and code integrations, information for the legacy API integrations and specifications used to call legacy APIs of the service provider (e.g., older and/or out-of-date APIs) may be determined and used for prompting. The data may include source code, as well as SDDs, source code files, source code change logs and/or informational logs, sample code and/or code snippets, desired code formats and/or code specifications or configurations, API specifications and/or call structures or requirements, legacy code integrations and/or legacy code, and the like.

An LLM prompt may be selected and configured or may be generated and/or provided for the specific request. The LLM prompt may correspond to one of multiple prompts, each prompt previously having been engineered for proper LLM instructing. For example, LLM prompts may be engineered based on instructions and data sets that were used to obtain proper responses from the LLM. A corresponding LLM prompt may be selected based on the merchant, request, code, computing service, and/or other parameter, and the LLM prompt may be updated or configured based on the LLM tokens and/or other input for the LLM. The LLM prompt may include the instructions, as well as a prompting strategy or set of calls to be executed for the prompting strategy, such as zero, one, and/or few-shot call prompting, question-and-answering prompting, chain-of-thought prompting, and the like.

LLMs may have token limits, such as a limit on “tokens” or units of data including words, characters, sets of words/characters, phrases, and the like, which may limit the amount of input received and processed by an LLM at a time. Token limits may establish a character limit, for example, and/or other limit on data size, such as to allow for proper processing of data (e.g. within predetermined time limits and/or accuracy), avoid incoherent or misleading responses, and/or allow for proper vectorization and/or other processing of the text or other input (e.g. within predetermined distance or accuracy thresholds). In this regard, the input data may exceed a token limit, resulting in multiple tokens for different code sections and/or code to be generated or migrated to a new code environment, format, and/or the like. The multiple tokens may be of the same size or of different sizes.

When prompting the first LLM, the aforementioned data for existing code 115 may be provided with a prompt, as well as any further data that may assist with identification of code integrations 114 in existing code 115, so that integration detection 143 may be performed. Integration detection 143 may be directly output for the entity's developers or other internal users assisting with integration merchant platform 112 with service applications 132, where the users may view the existing version of code integrations 114 and whether such versions have or are capable of being updated with or migrated to a new integration (e.g., use of a new or similar computing service or API for an existing service). However, in other embodiments, the first LLM or an ML engine that processes and output of the first LLM for integration detection 143 may make a recommendation to the entity of whether integrations to migrate to. The recommendation may consider difficulty in migrating, lost cost, downtime, and the like.

At step 406, an LLM is prompted to generate computing code for the code change. The LLM may correspond to a second LLM of AI system 146trained for code transformations, code migrations, and other code generative tasks. However, in other embodiments, the LLM may be the same as the first LLM used for code integration detection where such an LLM may be generalized to be responsive and accurate with both code integration detection and code transformation. In this regard, the second LLM may be trained to generate computer code from sample of computer code provided and a target or task for the computer code. In this regard, the second LLM may support generation of generated code 147 for implementing and/or utilizing one or more of service application 132 directly through merchant platform 112, which may be done through integration calls 134 in place of directing users. As such, generated code 147 may allow for merchant platform 112 to extend its functionality to include those computing services of service provider server 130 and may ensure that the integrations necessary to provide this functionality are kept up to date for security, efficiency, and functionality.

To generate new or replacement computer code for a particular task, such as a code integration of merchant platform 112 with service applications 132, the second LLM may require samples of code for the code integration on entity's platform, as well as samples of computer code for the target or desired version of the code integration. For example, a merchant (such as one or more of their code developers) may require source code for the code integration requested by the merchant. This may correspond to new and/or replacement code for a new integration and/or existing code migration, which may be generated by the LLM using code samples 144 for merchant platform 112, for code integrations 114 in existing code 115, as well as the target or desired version of the code integration. For example, the first LLM may be prompted using examples of the target, selected, or desired code, such as code samples 144 of the current, recommended, newest, or selected code that is to be implemented for code integrations 114 in order to migrate code integrations 114 to using the preferred computer code format, structure, contents (e.g., APIs, call endpoints, message structure or content, etc.) of the merchant and/or service provider. The examples of the target code for the current version may therefore include templates, code samples of the same or similar integration with other software platforms, and other documents or information that may be used in code development as discussed above.

At step 408, the recommendation and the computing code from the first and second LLMs is received. One or more LLMs responsible for performing integration detection 143 and provision of generated code 147 to the merchant or other entity may be accessed and/or utilized through a tool of code integration platform 140 when determining software platform code 141 for implementation with merchant platform 112. For example, separate LLMs may be used for code integration detection and code transformation, or a single LLM generalized for and/or capable of handling queries and input tokens in both domains may be used. The tools may be accessible through one or more UIs of a website, application, or other online portal accessible by developer device 120 and other similar requesters for code development. The UIs may provide an interface where conversational requests may be made to a generative AI including a chatbot or the like to receive assistance and/or services for integration detection 143 and generated code 147. The tools may therefore interact with and provide the interface between users and AI system 146 for the processes described herein, and may receive a recommendation of a code integration to be performed on merchant platform 112, as well as code generated for that integration. This may be returned as a code package, data file, response, code snippet or portion, or the like. When generating large section of code and/or handling large inputs, a code package may be generated by combining and/or stitching together computing code provided by the LLM(s) from prompting the LLM(s) in parts into a code package, which may allow for migration of code integrations for the computing service of the service provider.

At step 410, the recommendation and the computing code is output to the entity. The code and/or code package for generated code 147, as well as code integrations 114 detected by integration detection 143 with recommendation for migrations, may be pushed or sent to a selected computing system of the merchant via the tools of code integration platform 140, such the integration detection tool and the code transformation tool. These tools may provide and/or interface with a test computing environment, a production computing environment, and/or a code repository platform for review, testing, and/or analysis of the computer code, and other data files may be provided in their appropriate format and transmission method. For example, the merchant may request to receive the code directly for review and/or testing. However, the code may also be pushed to a code repository platform where multiple users, such as code developers, may access for review and/or testing. Further, a test or production computing environment may receive the code for testing or implementation, respectively.

Thus, using the above-described systems and methods, a more convenient and personalized environment, platform, and tools are provided to entities to facilitate the use of newer, more secure, and more efficient code integrations of software platforms. This may allow for the efficient and effective transmission and/or exchange of communications for data processing between separate software platforms. Merchants and other entities are provided with automated tools and AI components for detecting existing code integrations, as well as implement code for updated and recommended code integrations that may improve the performance and use of the merchant's software platform. These automated processes may limit and/or remove manual efforts that are time consuming and error prone, simplifying processes and providing more streamlined, efficient, and optimized computer code generation for improved software platform performance.

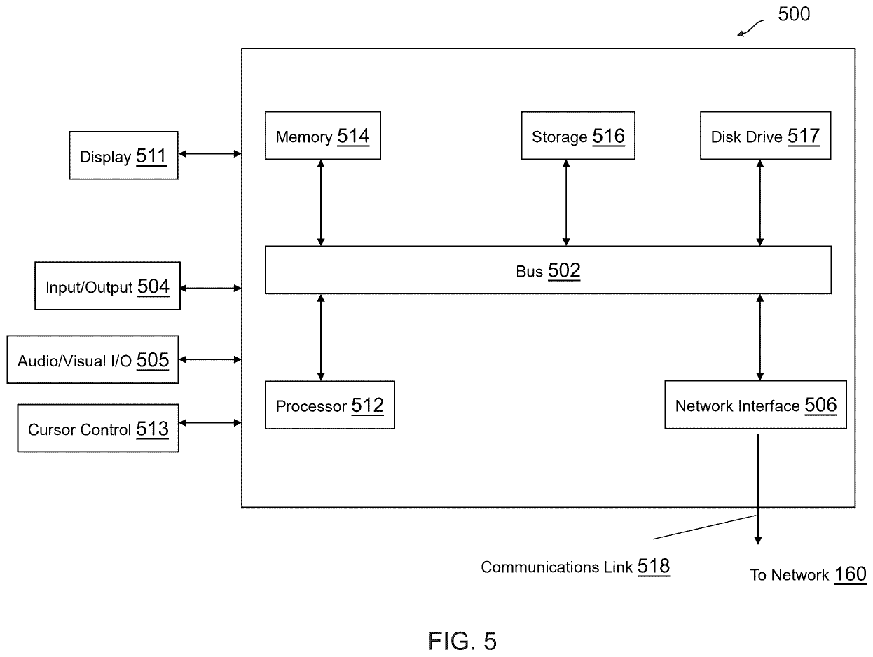

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
determine a first code integration existing between a software platform of an entity and a computing service processor of a service provider corresponding to the system, wherein the first code integration enables calls for data processing to be executed between the software platform and the computing service processor;
prompt a first large language model (LLM) to generate a recommendation for a code change that migrates the first code integration to a current version of service integration parameters for integrating with the computing service processor by software platforms, wherein the recommendation comprises conversational text output associated with migrating the first code integration to a second code integration based on the code change;
prompt a second LLM to generate computing code for the code change based on at least one of machine code for the software platform or call code for past calls executed by the software platform using the first code integration;
receive the recommendation and the computing code for the code change from the first LLM and the second LLM; and
output the recommendation and the computing code to the entity via one or more user interfaces.

2. The system of claim 1, wherein, prior to determining the first code integration, executing the instructions further causes the system to:
receive a request associated with integrating the software platform with the computing service processor, wherein the request comprises a payload associated with the software platform that indicates the first code integration, and wherein the payload indicates a set of legacy application programming interfaces (APIs) previously used with the computing service processor by the software platform for the first code integration.

3. The system of claim 2, wherein the request is to migrate from the set of legacy APIs including at least one SOAP (Simple Object Access Protocol) API to a set of current APIs including at least one representational state transfer (REST) API.

4. The system of claim 1, wherein determining the first code integration comprises:
scanning code files for the software platform of the entity; and
performing an offline detection of the first code integration from the software platform based on the scanned code files, wherein the offline detection identifies the first code integration independent of an account of the entity with the service provider.

5. The system of claim 4, wherein the scanning the code files comprises at least one of parsing the machine code of the software platform for the first code integration or inferring the first code integration from the call code for the calls for data processing enabled by the first code integration.

6. The system of claim 1, wherein determining the first code integration comprises:
determining an account of the entity with the service provider; and
performing an online detection of the first code integration based on data associated with the account, wherein the data comprises at least one of past code integrations used by the entity, the call code for the past calls executed by the software platform, or computing services of the service provider used by the entity via the software platform.

7. The system of claim 1, wherein prompting the second LLM to generate the computing code comprises:
accessing a code transformation assistant;
receiving, using the code transformation assistant, sample code for at least one of the first code integration or the current version of the service integration parameters associated with the computing service processor; and
generating the computing code using the second LLM and based at least on the machine code for the software platform and the sample code, wherein the computing code, when executed, utilizes the current version of the service integration parameters on the software platform.

8. The system of claim 7, wherein the computing code comprises one of new executable instructions that replace previous executable instructions for source code of the software platform or a fork in the source code to the new executable instructions from the previous executable instructions.

9. The system of claim 1, wherein prompting the first LLM includes generating an LLM prompt for the first LLM based on the first code integration and the current version of the service integration parameters, and wherein the first LLM is configured to recommend changes to existing code integrations based on LLM training data associated with available code integrations for the service provider.

10. The system of claim 1, wherein prompting the second LLM includes generating an LLM prompt for the second LLM based on source code for the latest version of the service integration parameters and at least one of the machine code or the call code.

11. A method comprising:
determining a first code integration existing between a software platform of an entity and a computing service based on an account of the entity used with the computing service and one or more calls exchanged between the software platform and the computing service, wherein the first code integration enables the software platform to utilize the computing service for data processing via the one or more calls;
providing the entity with information of the first code integration and a latest version of service integration parameters for integrating with the computing service;
generating new code for a second code integration using a generative artificial intelligence (AI) and based on the account of the entity, the one or more calls exchanged, and existing code for the first code integration, wherein the new code is utilized to replace the existing code for a code migration from the first code integration to the second code integration; and
outputting the new code to the entity via a user interface.

12. The method of claim 11, wherein the determining the first code integration is performed based on an account that the entity uses to log on with a service provider corresponding to the computing service, and wherein the first code integration is further determined based on a version of computing code for the first code integration that was associated with the account based on the account being used in one or more transactions facilitated using the one or more calls.

13. The method of claim 12, wherein the determining the first code integration comprises parsing computing code of the one or more calls for the version of computing code that is utilized by the software platform of the entity for the first code integration.

14. The method of claim 13, wherein the determining the first code integration comprises identifying the version of computing code from a plurality of versions of computing code based on at least one of a software development kit, an application programming interface (API) specification, or a developer tool provided for code integrations of different entities with the computing service.

15. The method of claim 11, wherein the determining the first code integration comprises constructing a prompt for the generative AI using at least one of contextual information for the first code integration, an outline or template for prompting the generative AI for code generation, or a prompting strategy for the generative AI.

16. The method of claim 15, wherein the prompting strategy comprises a one-shot example or few-shot examples with one or more examples of computing code for a sample code integration.

17. The method of claim 11, wherein, prior to the determining the first code integration, the method further comprises:
obtaining a consent from the entity to scan entity files on a computer system of the entity to determine the first code integration; and
scanning the entity files on the computer system based on receiving the consent.

18. The method of claim 11, wherein the outputting the new code to the entity via a user interface comprises providing a tool to assist with code transformations on a digital platform that is accessible by the entity.

19. A non-transitory machine-readable medium having stored thereon machine-readable instructions executable to cause a machine to perform operations comprising:
determining a code integration utilized by a software platform of an entity to interface with a computing service of a service provider based on at least one of an account of the entity or one or more calls exchanged between the software platform and the computing service;
identifying a newer version of at least one of a template of computing code or a sample of computing code usable for the code integration with the computing service;
generating new computing code usable by the software platform of the entity for the code integration using an artificial intelligence (AI) model and based on the account or the one or more calls exchanged, wherein the new code is utilized to replace existing computing code being utilized by the software platform for the code integration; and
outputting the new computing code to the entity via a user interface.

20. The non-transitory machine-readable medium of claim 19, wherein the new computing code is generated using the AI model by prompting the AI model using the newer version of the at least one of the template of the computing code or the sample of computing code, one or more portions of the existing computing code, and an instruction.
